(19) United States
(12) Patent Application Publication
(10) Pub. No.: US 2014/0261227 A1
(43) Pub. Date: Sep. 18, 2014

(54) LIVESTOCK GROOMING ARTICLE

(71) Applicant: SULLIVAN SUPPLY, INC., Dunlap, IA (US)

(72) Inventors: John Sullivan, Dunlap, IA (US); Scott Kinzer, Denison, IA (US)

(73) Assignee: SULLIVAN SUPPLY, INC., Dunlap, IA (US)

(21) Appl. No.: 14/212,470

(22) Filed: Mar. 14, 2014

Related U.S. Application Data
(60) Provisional application No. 61/791,400, filed on Mar. 15, 2013.

(51) Int. Cl. A01K 13/00

(52) U.S. Cl. CPC A01K 13/002
USPC 119/625; 427/256; 427/466

(57) ABSTRACT

Livestock grooming articles and methods regarding the use of such livestock grooming articles are disclosed. In one or more embodiments, a livestock grooming article can include coatings configured to inhibit or reduce the buildup of adhesives on the livestock grooming article that are applied to livestock animal hair. In one or more embodiments, the livestock grooming article can increase the appearance of volume to the hair of livestock.

### CROSS-REFERENCE

This application claims the benefit of U.S. Provisional Application No. 61/791,400 filed Mar. 15, 2013, the disclosure of which is incorporated herein by reference.

### FIELD

This application relates to, among other things, livestock grooming articles and livestock grooming methods.

### BACKGROUND

There exists a specialized industry for grooming of livestock, including but not limited to, cattle, sheep, goats, swine, horses, etc. When livestock are shown in competition or brought to auction, the owners of the livestock often desire grooming styles that create the appearance of greater volume, such as styles that cause the hair to stand on end, adding localized bulk to the appearance of the animal. Often the appearance of added volume is desired in the leg area, etc. Grooming livestock is different than grooming other animals and requires grooming methods with increased strength and durability due to their hair and hide characteristics, but also because of the environments that livestock live in.

The environments livestock live in can be dirty, dusty, wet, muddy, hay-filled and/or windy. Accordingly, specialized tools and methods are desirable in these applications. In addition, chemical products used for grooming livestock, particularly in preparation for competition or auction, are different than chemical products that are used on pets or humans.

### BRIEF SUMMARY

In various embodiments, the present disclosure describes, among other things, specialized tools and methods to provide livestock with increased hair volume or a fuller appearance of the hair by allowing the groomer the ability to lift and hold the hair in any desired direction, and to separate the hairs from each other such that they do not clump or stick together.

Furthermore, the specialized tools and methods described herein provide these benefits without pulling of the hair or the hide of the animal. This is important because relaxed livestock generally show better. With conventional tools and methods, pulling the hair or hide of the animal can easily occur, especially if the user is a novice. Pulling the hair or the hide not only has the undesirable effect of reducing actual hair volume, it also causes the animal to become aggravated, which adversely affects the livestock from showing well.

Additionally, the specialized tools and methods described herein provide for a quicker grooming process that is more efficient for the groomer or user, and more pleasing to the animal as the animal may spend less time in a grooming chute.

Various embodiments of the apparatuses and methods described herein may have one or more advantages relative to existing livestock grooming articles. For example, conventional livestock grooming articles tend to suffer from adhesive buildup when grooming an animal in a process involving adhesive, which is typical for livestock. Livestock grooming adhesive is very strong, very tacky, and dries very quickly, much more so than products traditionally used on human hair. With the previous uncoated grooming articles, including, for example, uncoated combs (or brushes, etc.), the adhesive coated hair easily sticks to the tines, teeth or bristles, pulling out hair from the animal. Pulling out hair is undesirable because, not only does it aggravate the animal, the goal is to have as much hair as possible to create the appearance of more volume with the hair. When too much hair is pulled out, it is more difficult or impossible to shape the hair as desired because there is less hair overall. In contrast, the grooming articles described in embodiments herein include a coating configured to reduce adhesive buildup and thereby reduce hair pulling and improve grooming ease.

Additionally, with conventional uncoated combs that tend to suffer from adhesive buildup, the groomer has to stop and clean the comb repeatedly before continuing the grooming process. In embodiments described herein, the coated livestock grooming article experiences less adhesive buildup, which creates a much improved grooming performance of the adhesives. The coated livestock grooming articles allow the tines to pass through the hair much easier, with less drag, allowing the adhesive coated hair to separate easily, further preventing undesirable matting of the adhesive coated hair that occurs with conventional livestock grooming articles.

In one aspect, the present disclosure provides a livestock grooming article that includes a handle having a longitudinal axis, and an elongate member extending from a first end to a second end along an elongate member axis. The handle is coupled to the elongate member and extends away from the elongate member. The longitudinal axis of the handle is substantially orthogonal to the elongate member axis. The article further includes a plurality of tines, each of the plurality of tines extending from the elongate member substantially perpendicular to the elongate member axis. The plurality of tines are coated with a coating configured to reduce or prevent adhesive buildup on the livestock grooming article.

In another aspect, the present disclosure provides a method of using a livestock grooming article. The method includes applying an adhesive to hair of a livestock animal, and combing the hair of the livestock animal to which the adhesive has been applied with the livestock grooming article. The livestock grooming article includes a handle having a longitudinal axis, and an elongate member extending from a first end to a second end along an elongate member axis. The handle is coupled to the elongate member and extends away from the elongate member. The longitudinal axis of the handle is substantially orthogonal to the elongate member axis. The livestock grooming article further includes a plurality of tines, each of the plurality of tines extending from the elongate member substantially perpendicular to the elongate member axis. The plurality of tines are coated with a coating configured to reduce or prevent adhesive buildup.

In another aspect, the present disclosure provides a method of coating a livestock grooming article with a non-stick coating configured to reduce or prevent adhesive buildup. The method includes applying the coating to the portion of the livestock grooming article.

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

FIG. 1a is a perspective view of an embodiment of a livestock grooming article.

FIG. 1b is a perspective view of another embodiment of a livestock grooming article.

FIG. 2 is a perspective view of yet another embodiment of a livestock grooming article.

FIG. 3 is a flow diagram of an overview of methods described herein.

The drawings are not necessarily to scale. Like numbers used in the figures refer to like components, steps and the like. However, it will be understood that the use of a number to refer to a component in a given figure is not intended to limit the component in another figure labeled with the same number. In addition, the use of different numbers to refer to components is not intended to indicate that the different numbered components cannot be the same or similar.

### DETAILED DESCRIPTION

In the following detailed description, reference is made to the accompanying drawings that form a part hereof, and in which are shown by way of illustration several specific embodiments of devices, systems and methods. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a,” “an,” and “the” encompass embodiments having plural referents, unless the content clearly dictates otherwise.

As used in this specification and the appended claims, the term “or” is generally employed in its sense including “and/or” unless the content clearly dictates otherwise.

As used herein, “have,” “having,” “include,” “including,” “comprise,” “comprising,” or the like are used in their open ended sense, and generally mean “including, but not limited to.” It will be understood that the terms “consisting of” and “consisting essentially of” are subsumed in the term “comprising,” and the like. For example, a livestock grooming article comprising tines, the elongate member, and the handle may consist of, or consist essentially of, the tines, the elongate member and the handle.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

Various embodiments of the articles and methods described herein may have one or more advantages relative to existing livestock grooming articles. For example, in various embodiments, the present disclosure describes, among other things, specialized tools and methods to provide livestock with increase volume, or a fuller appearance of the hair by allowing the groomer the ability to lift and hold the hair in any desired direction and to separate the hairs from each other such that they do not clump together.

Furthermore, the specialized tools and methods described herein provide these benefits without pulling of the hair or the hide of the animal. This is important because relaxed livestock generally show better. With conventional tools and methods, pulling the hair or hide of the animal can easily occur, especially if the user is a novice. Pulling the hair or the hide not only has the undesirable effect of reducing actual hair volume, it also causes the animal to become aggravated, which adversely affects the livestock from showing well.

Additionally, the articles and methods described herein provide for a quicker grooming process that is more efficient for the groomer or user, and more pleasing to the animal as the animal may spend less time in a grooming chute.

The disclosed embodiments of FIGS. 1-3 are presented for purposes of illustration and not limitation. FIGS. 1-3 depict various geometries of suitable livestock grooming articles, including combs, brushes or rakes, or methods of use thereof It will be understood that any suitable livestock grooming article geometry may be used in combination with the features described herein. It will be understood that other suitable geometry not specifically depicted herein may be used without departing from the scope or spirit of the present disclosure.

Referring now to FIG. 1a, a perspective view of an embodiment of a livestock grooming article 100 is shown. The livestock grooming article 100 includes a handle 110 extending along a longitudinal handle axis 112 and an elongate member 120 that supports a plurality of tines 130 such as one or more rows of tines. The elongate member 120 extends from a first end 124 to a second end 126 along an elongate member axis 122. The handle 110 can be any suitable dimension or dimensions. Further, the elongate member 120 can also be any suitable dimension or dimensions, e.g., a distance between the first end 124 and the second end 126 can be any suitable length.

The handle 110 may be coupled to the elongate member 120 in any suitable location along the elongate member. In one or more embodiments, the handle 110 is coupled to the elongate member 120 at a central region 128 of the elongate member 120. The handle 110 extends away from elongate member 120.

In one or more embodiments, the plurality of tines 130 extend from the elongate member 120 in a manner substantially orthogonal to the elongate member axis 122, i.e., along tine axis 132. The plurality of tines 130 may be arranged at any suitable angle relative to the handle axis 112, i.e., the tine axis 132 can be oriented at any suitable angle relative to the handle axis 112. For example, in one or more embodiments, the angle between the tine axis 132 and the handle axis 112 can be greater than 0°. In one or more alternative embodiments, the angle between the tine axis 132 and the handle axis 112 can be no greater than 180°. In one or more embodiments, the plurality of tines 130 may be arranged substantially orthogonal to the handle axis 112, i.e., the angle between the tine axis 132 and the handle axis 112 can be about 90°.

The handle axis 112 may be arranged at any suitable angle relative to the elongate member axis 122. In one or more embodiments, and as shown in FIG. 1a, the handle axis 112 may be arranged substantially orthogonal to the elongate member axis 122. This orthogonal arrangement of the handle 110 to both the elongate member 120 and the plurality of tines 130 provides an ergonomically favorable geometry for grooming livestock, allowing the user to easily pull the tines through the livestock's hair and to easily reach both high and low locations on the livestock's body.

In one or more embodiments, and as shown in FIG. 1a, the plurality of tines 130 may be of substantially equal length and/or diameter. The plurality of tines 130 of FIG. 1a may further be of varying diameter along their length (e.g., generally conical, or formed as a cylinder of increasing or decreasing diameter along the tine) or include tines of varying diameter as compared to one another. In one or more embodiments, the tines of the plurality of tines may be spaced apart from each other any suitable distance. Further, in one or more embodiments, the tines may be regularly spaced or irregularly spaced.

In numerous other embodiments, as shown in FIG. 1b, the handle 210 and elongate member 220 of livestock grooming article 200 are substantially the same as the handle 110 and elongate member 120 of livestock grooming article 100 in the embodiment of FIG. 1a. All of the design considerations and possibilities regarding the livestock grooming article 100 of FIG. 1a apply equally to the livestock grooming article 200 of FIG. 1b.

In contrast to the embodiment of FIG. 1a, the grooming article 200 in the embodiment depicted in FIG. 1b includes tines 230 of varying lengths. The lengths of tines 230 may alternate between long and short tines, they may be arranged in a pattern, include randomly arranged lengths, or otherwise be arranged. The plurality of tines 230, of FIG. 1b may further be of varying diameter along their length (e.g., generally conical, or formed as a cylinder of increasing or decreasing diameter along the tine) or include tines of varying diameter as compared to one another. It will be understood that any suitable tine configuration or combination of configurations may be used and need not include the specific configurations shown.

Referring now to FIG. 2, a perspective view of another embodiment of a livestock grooming article 300 is shown. All of the design considerations and possibilities regarding livestock grooming articles 100, 200 of FIGS. 1a-b apply equally to livestock grooming article 300 of FIG. 2. The handle 310 and the handle arrangement to the elongate member 320 of the livestock grooming article 300 is substantially similar in geometry to the livestock grooming articles 100, 200 of FIGS. 1a-b. As shown in FIG. 2, and in one or more embodiments, the plurality of tines 330 extending from the elongate member 320 extend in a manner substantially orthogonal to the elongate member axis 322, i.e., along tine axis 332. Additionally, the plurality of tines 330 may be arranged substantially orthogonal to the handle axis 312.

In contrast to grooming articles depicted in the embodiments of FIGS. 1a-b, the grooming article 300 depicted in the embodiment shown in FIG. 2 may include both a plurality of tines 330 that includes a first row of tines 340 extending away from the elongate member 320 in a first direction 342, and a second row of tines 350 extending away from the elongate member in a second direction 352. In one or more embodiments, the first direction 342 and the second direction 352 are substantially opposite directions to each other. The first direction 342 and the second direction 352 may be oriented substantially 180° from one another, or in a range of 170-190° from each other, or 160-190° from each other, or 150-200° from each other.

Further, any suitable angle can be formed between the first direction 342 and the handle axis 312. In one or more embodiments, the angle between the first direction 342 and the handle axis 312 can be greater than 0°. In one or more embodiments, the angle between the first direction 342 and the handle axis 312 can be no greater than 180°.

Any suitable angle can be formed between the second direction 352 and the handle axis 312. In one or more embodiments, the angle between the second direction 352 and the handle axis 312 can be greater than 0°. In one or more embodiments, the angle between the second direction 352 and the handle axis 312 can be no greater than 180°.

In one or more embodiments and as shown in FIG. 2, the first row of tines 340 may be of substantially equal length and/or diameter, while the second row of tines 350 may be of varying lengths or vice versa. As discussed in reference to FIGS. 1a-b, the lengths may alternate between long and short tines, they may be arranged in a pattern, include randomly arranged lengths, or otherwise be arranged. Either or both of the first row of tines 340 and the second row of tines 350 may be of equal or varying diameters along their length (e.g., generally conical, or a cylinder of increasing or decreasing diameter along the tine) or include tines of varying diameter as compared to one another. Any number of rows, any combination of row or tine arrangement or geometry that is suitable for grooming livestock may be used.

It will be understood that any suitable materials or combination of materials may be used to form the livestock grooming article of FIGS. 1a-b and 2, including but not limited to, metal, plastic, ceramics and wood.

The grooming articles and components thereof, such as tines, may be of any suitable dimension.

In the embodiments shown in FIGS. 1a-b and 2, and in numerous other embodiments, the plurality of tines 130, 230, 330 and/or the elongate member 120, 220, 320, or any other suitable portion of the grooming article 100, 200, 300 can be coated with a coating configured to inhibit, reduce, or prevent adhesive buildup. Coating all or a portion of the livestock grooming article 100, 200, 300 (or a portion configured to contact the animal's coat or hide) allows a user to more easily use the livestock grooming article 100, 200, 300 when livestock grooming adhesive is applied to the livestock's hair. Coating the livestock grooming article with a coating configured to reduce or prevent adhesive build up can yield excellent performance while grooming with adhesive. Other livestock grooming articles, including conventional uncoated metal or plastic combs, typically yield less desirable results.

Coating all or a portion of the livestock grooming article 100, 200, 300 with a coating configured to reduce or prevent adhesive buildup enables the plurality of tines 130, 230, 330 of the livestock grooming article 100, 200, 300 to easily pass through hair of an animal to which a strong grooming adhesive has been applied. Less resistance while passing through adhesive coated hair prevents pulling of the hair or hide.

The coating configured to reduce or prevent adhesive buildup may include a non-stick release coating or an anti-stick coating. The coating has a lower coefficient of friction than the uncoated surface of the plurality of tines 130, 230, 330 or the elongate member 120, 220, 320. Preferably, the non-stick release coating or anti-stick coating prevents or inhibits adhesive buildup and/or improves the ability to remove adhesive buildup on the livestock grooming article.

Any suitable non-stick, anti-stick, etc. coating may be employed. In one or more embodiments, the coating can include a fluoropolymer or blends of fluoropolymers. Any suitable fluoropolymer or fluoropolymers can be utilized, e.g., the fluoropolymer can include, e.g., polytetrafluoroethylene (PTFE), such as TEFLON® made by Dupont, or XYLAN® made by the Whitford Corporation, polyvinylfluoride (PVF), polyvinylidene fluoride (PVDF), polychlorotrifluoroethylene (PCTFE), perfluoroalkoxy polymer (PFA), fluorinated ethylene-propylene (FEP), polyethylenetetrafluoroethylene (ETFE), polyethylenechlorotrifluoro ethylene (ECTFE), perfluorinated elastomer [perfluoroelastomer] (FFPM/FFKM), fluorocarbon [chlorotrifluoroethylenevinylidene fluoride] (FPM/FKM), perfluoropolyether (PFPE), perfluorosulfonic acid (PFSA), and combinations or blends thereof. But it is understood that any suitable non-stick release or anti-stick coating, additive, or blend may be used.

The coating can be applied to a portion (e.g., surface) of a livestock grooming article using any suitable technique or combination of techniques. For example, in one or more embodiments, a livestock grooming article (e.g., any livestock grooming article described herein) can be coated with a coating configured to reduce or prevent adhesive buildup. The method can include applying the coating to a portion of the livestock grooming article. In one or more embodiments, the portion can include any portion of the livestock grooming article, e.g., one or more tines of the plurality of tines, the elongate member, etc. In one or more embodiments, the method can also include abrading a portion of the livestock grooming article before applying the coating to the portion of the livestock grooming article. Any suitable technique or combination of techniques can be used to abrade the portion, e.g., sandblasting, sanding, chemical abrading, etc. In one or more embodiments, a primer layer can be applied to the portion instead of, before, or after abrading the portion of the livestock grooming article. For example, in one or more embodiments, the primer layer can be applied to the portion of the livestock grooming article before applying the coating to the livestock grooming article.

The portion (or the entire article) can be washed after abrading the livestock grooming article but before the coating is applied to remove any dirt or particulates that remain. Any suitable technique or combination of techniques can be used to wash the portion, e.g., washing with water or any suitable chemical or chemicals. In one or more embodiments, the washed portion can be dried using any suitable technique or combination of techniques.

The coating can be applied to the portion of the livestock grooming article using any suitable technique or combination of techniques. In one or more embodiments, the portion can be powder coated, e.g., by electrostatically charging the portion and depositing the coating onto the charged portion. In one or more alternative embodiments, the coating can be applied using chemical vapor deposition, plasma vapor deposition, dip coating, curtain coating, spray coating, liquid coating, etc.

The applied coating can be cured using any suitable technique or combination of techniques. In one or more embodiments, the coating can be thermally cured. In one or more embodiments, the coating can be photo-cured, e.g., UV cured.

An example of a method of grooming a livestock animal is depicted in FIG. 3. The method includes applying a livestock grooming adhesive to the hair of a livestock animal (400) and combing the hair of the livestock with a grooming article as described herein (410). The livestock grooming adhesive may be applied by spraying or rubbing adhesive on to the animal, by applying it first to the livestock grooming article and transferring it to the hair of the livestock animal via the livestock grooming article, or applying the adhesive in any other suitable manner.

The adhesive may be any adhesive suitable for grooming livestock. In one or more embodiments, preferred livestock grooming adhesives are sufficiently strong to cause the hair of the livestock animal to stand on end after grooming. In one or more embodiments, the adhesive provides the appearance of more volume to the hair when used in a grooming process.

During or after application of the adhesive, the user (groomer) combs the hair of the livestock animal to which the adhesive has been applied with the livestock grooming article (e.g., as described herein regarding FIGS. 1a-b and 2). Combing the hair of the livestock animal may include combing the hair of the livestock animal in any suitable direction The method may further include temporarily holding the hair in a lifted position for a period of time.

As described herein, a portion of the livestock grooming article, e.g., the plurality of tines and/or elongate member from which the tines extend, are coated with a coating configured to inhibit, reduce, or prevent adhesive buildup (non-stick release coating or anti-stick coating) on the livestock grooming article.

Grooming the livestock animal in this manner, with such a livestock grooming article, produces better results than conventional methods. The benefit of this method is that it produces excellent performance while grooming with adhesive. The coated livestock grooming article (e.g., for example, comb or brush) sticks much less to the hair. The non-stick release coating on the livestock grooming article produces less resistance while passing through the adhesive coated hair, resulting is less pulling of the hair. The reduction in drag on the hair also allows the adhesive coated hair to separate, easily reducing matting of the adhesive coated hair, and thus increasing the appearance of greater volume of the hair.

It will be understood that the steps in the depicted methods may be performed in any suitable order and need not follow the order depicted in FIG. 3. It will also be understood that the methods depicted in FIG. 3 may be practiced together with other methods, or independently.

The livestock grooming articles and methods described herein may be used in their entireties to provide enhanced livestock grooming results. Various components described herein may be used with known livestock grooming articles and methods to enhance livestock grooming results. For example, the non-stick release coating features described herein may be used with other livestock combs and livestock brush designs.

Thus, embodiments of the ARTICLE AND METHOD FOR GROOMING LIVESTOCK are disclosed. One skilled in the art will appreciate that the present disclosure can be practiced with embodiments other than those disclosed. The disclosed embodiments are presented for purposes of illustration and not limitation.

What is claimed is:

1. A livestock grooming article, comprising:
a handle having a longitudinal axis;
an elongate member extending from a first end to a second end along an elongate member axis, wherein the handle is coupled to the elongate member and extends away from the elongate member, wherein the longitudinal axis of the handle is substantially orthogonal to the elongate member axis; and
a plurality of tines, each of the plurality of tines extending from the elongate member substantially perpendicular to the elongate member axis, wherein the plurality of tines are coated with a coating configured to reduce or prevent adhesive buildup on the livestock grooming article.

2. The livestock grooming article of claim 1, wherein the elongate member is coated with the coating configured to prevent adhesive buildup on the livestock grooming article.

3. The livestock grooming article of claim 1, wherein the coating is a non-stick coating.

4. The livestock grooming article of claim 1, wherein a surface of the coating has a lower coefficient of friction than an uncoated surface of the plurality of tines.

5. The livestock grooming article of claim 1, wherein the coating improves the ability to remove adhesive buildup on the livestock grooming article.

6. The livestock grooming article of claim 1, wherein the coating configured to prevent adhesive build up comprises a fluoropolymer.

7. The livestock grooming article of claim 1, wherein the handle is coupled to the elongate member at a central region of the elongate member.

8. The livestock grooming article of claim 1, wherein the plurality of tines comprises a first row of tines and a second row of tines, wherein the first row of tines extends away from the elongate member in a first direction, and the second row of tines extends away from the elongate member in a second direction.

9. The livestock grooming article of claim 8, wherein the first row of tines comprises long tines and short tines arranged in an alternating pattern, and wherein the second row of tines comprises tines of substantially equal length to one another.

10. The livestock grooming article of claim 1, wherein the plurality of tines are substantially orthogonal to the handle.

11. A method of using a livestock grooming article, wherein the method comprises:
applying an adhesive to hair of a livestock animal;
combing the hair of the livestock animal to which the adhesive has been applied with the livestock grooming article, wherein the livestock grooming article comprises:
a handle having a longitudinal axis;
an elongate member extending from a first end to a second end along an elongate member axis, wherein the handle is coupled to the elongate member and extends away from the elongate member, wherein the longitudinal axis of the handle is substantially orthogonal to the elongate member axis; and
a plurality of tines, each of the plurality of tines extending from the elongate member substantially perpendicular to the elongate member axis, wherein the plurality of tines are coated with a coating configured to reduce or prevent adhesive buildup on the livestock grooming article.

12. The method of claim 11, wherein the handle is coupled to the elongate member at a central region of the elongate member.

13. A method of coating a livestock grooming article with a non-stick coating configured to reduce or prevent adhesive buildup on the livestock grooming article, wherein the method comprises applying the coating to a portion of the livestock grooming article.

14. The method of claim 13, further comprising abrading the portion of the livestock grooming article before applying the coating to the portion of the livestock grooming article.

15. The method of claim 14, wherein abrading the portion of the livestock grooming article comprises sandblasting the portion of the livestock grooming article.

16. The method of claim 14, further comprising washing the portion of the livestock grooming article after abrading the portion of the livestock grooming article and before applying the coating to the portion of the livestock grooming article.

17. The method of claim 13, further comprising applying a primer layer to the portion of the livestock grooming article before applying the coating to the portion of the livestock grooming article.

18. The method of claim 13, further comprising curing the coating after the coating is applied to the livestock grooming article.

19. The method of claim 18, wherein curing the coating comprises thermally curing the coating.

20. The method of claim 13, wherein applying the coating comprises electrostatically charging the portion of the livestock grooming article and depositing the coating onto the charged portion.
